(19) United States
(12) Patent Application Publication
(10) Pub. No.: US 2013/0216973 A1
(43) Pub. Date: Aug. 22, 2013

(54) Coating for a dental matrix band

(71) Applicant: Robert Haraden, (US)

(72) Inventor: Robert Haraden, (US)

(21) Appl. No.: 13/317,429

(22) Filed: Oct. 18, 2011

(51) Int. Cl. A61C 5/04; B05D 3/12; G03F 7/20; B05D 3/10

(52) U.S. Cl. 433/39; 427/2.26; 430/320

(57) ABSTRACT

A matrix band for use in dentistry has a silicone-based, polymer coating applied to an etched stainless steel surface, which reduces or eliminates capillary action between a tooth and the matrix band, while at least one aperture in the matrix band assists with removal of the matrix band from the tooth.

### This invention relates to a coating for a dental matrix band and more particularly to a coating for a dental matrix band based on silicone applied to an etched dental matrix band.

### BACKGROUND OF THE INVENTION

A matrix band is a common tool used in dentistry. Typically, the matrix band is a thin, flexible piece of material. Generally speaking, the matrix band is metallic in nature. After the dentist prepares the tooth and removes decay, the dentist will position the band around a tooth to be filled. The band is then tightened around the tooth, with a clamping device called a dental matrix band retainer, in order to form a mold or an appropriate support for applying a filling material to the tooth.

The matrix band of the prior art is metallic, usually comprising stainless steel. The matrix band must be substantially impervious to, or not reactive with, fluids in a person's mouth. The matrix band must also be made of a metal that is nontoxic. Because the use of a dental matrix band is well defined in U.S. Pat. No. 5,586,883 to Nakisher and Uditsky, incorporated herein by reference, the use thereof need not be further defined.

There are a number of different dental matrix bands or devices currently on the market; Universal Adult Matrix Band (available in sizes of 0.0015 inch and 0.002 inch); Adult Molar Matrix Band; Child Matrix Band;

and Auto Matrix System.

Although the matrix band is a common and long-used dental implement, problems do exist with the currently used technology. Firstly, capillary action between the matrix band and the tooth causes at least one body fluid, to dampen or contaminate the surface of the tooth being filled. This is extremely undesirable since the presence of an undesirable fluid in the area interferes with the adhesion property and reduces the bond strength of the cavity filling material to the tooth, and causes deterioration of the cavity filling material.

Typically, body fluids interfere with this dental restorative procedure include, but are not limited to, blood and saliva. Interference is caused between the tooth and the filling material, because the optimum bond strength of a filling to a tooth occurs when the tooth remains dry during the entire procedure, and the mechanical strength of the filling material to be maximized.

Another difficulty with a matrix band of the prior art is the tendency of the bands to adhere to the cavity filling material. This adherence may make the matrix band difficult to remove from the tooth, when the filling process is complete, and may require the dentist to exert extra force on the new composite filling used on the patient in order to remove that matrix band. A difficult removal of the sticking matrix band is uncomfortable for the patient, and causes both weakness of the bond between the cavity filling material and the filling material to leak overtime, thereby reducing the longevity of the dental filling. Without a good bond between filling material and the tooth, the dental procedure significantly increases the probability of recurrent decay.

Still another difficulty of currently utilized matrix bands is the flat surface of the bands, which contain no indentations where a dental instrument can be used to grasp the band to assist in removing the band after the cavity has been filled. This makes the removal of the band more difficult.

Many devices are known in the prior art, which allegedly permit easy removal of a matrix band from a tooth. One attempt to solve the problem included making the matrix band with a gold plating. However, this ultra-thin layer of gold-plated matrix band does not completely solve or eliminate the ingress of fluid, which causes contamination and undesired body fluid flow into the desired work area.

While it is not desired to be bound by any particular theory, the capillary action is believed to occur because the solid gold or gold alloy matrix band, as well as the gold-plated matrix band is not soft enough or thick enough to form a seal with the tooth, thereby failing to eliminate the ingress of fluid due to capillary action.

While polymer coatings can successfully form a seal with the tooth, the adherence of the polymer to the matrix band or the separating strip for dental purposes is often defective. If the coating does not properly adhere to the matrix band, the coating shears off the stainless steel and remains stuck between the teeth or may remain in the composite dental filling material.

### SUMMARY OF THE INVENTION

Among the many objectives of this invention is the provision of a dental matrix band seal in combination with a matrix band, the matrix band being coated with a silicone-based polymer, which at least minimizes the ingress of fluid between the matrix band and the tooth, by creating a seal which keeps the surface of the tooth dry during the filling process.

Another objective of this invention is the provision of a dental matrix band seal in combination with a matrix band with at least one aperture on the band to assist in the removal of the band from the tooth when the filling procedure is completed.

Yet another objective of this invention is the provision of a dental matrix band seal in combination with a matrix band, which is nontoxic to the patient.

Still another objective of this invention is the provision of a dental matrix band seal in combination with a matrix band, with a silicone-based polymer coating thereon.

These and other objectives of the invention (which other objectives become clear by consideration of the specification, claims and drawings as a whole) are met by providing a matrix band for use in dentistry, wherein the matrix band has a silicone-based, polymer coating applied to an etched stainless steel surface, which reduces or eliminates capillary action between a tooth and the matrix band, while at least one aperture in the matrix band assists with removal of the matrix band from the tooth.

### BRIEF DESCRIPTION OF THE DRAWINGS

FIG. 1 depicts a perspective view of a straight coated matrix band 100 with a silicon polymer 120 of this invention.

FIG. 2 depicts a perspective view of a straight coated matrix band 100 with a silicone polymer 120 of this invention, with a partial cross-section.

FIG. 3 depicts a side, cross-sectioned view of the straight coated matrix band 100 of this invention based on FIG. 2.

FIG. 4 depicts a side view of the straight coated matrix band 100 based on FIG. 2 around tooth 110.

Throughout the figures of the drawings, where the same part appears in more than one figure of the drawings, the same number is applied thereto.

### DESCRIPTION OF THE PREFERRED EMBODIMENTS

With the matrix band of this invention being suitable for use in dental procedures and having a coated surface thereon, capillary action between the tooth and the band is at least substantially reduced, if not eliminated.

The concept disclosed and claimed herein may be described as a dental matrix seal and is applicable to any dental matrix device, regardless of the geometric shape of the dental matrix device. The geometric shape of the seal is irrelevant to the function of the seal. The advantages of using a Silicone coated dental matrix band are as follows:
1) Using Silicone coating on the stainless steel dental matrix band eliminates or reduces the roughness of the surface of the dental matrix band both the plain stainless steel and the tin coated stainless steel. The rough surface causes the composite dental filling material to stick to the dental band and cause the filling material to be rough inter-proximally (between the two adjacent teeth) This inter-proximal surface can not be smoothed after the dental filling has been placed. When the dental matrix band sticks to the filling material the band fractures and breaks upon removal causing the band to be dangerous to the operator (dentist or assistant).
2) The Silicone coating requires less tightening torque on the matrix band Tofflemere retainer to achieve a seal of the tooth dental preparation area from body fluids (saliva and blood). The reduction in torque on the dental matrix band eliminates the potential of the dental matrix band from fracturing and breaking during the application procedure.
3) The Silicone coating eliminates the capillary action, wicking or osmotic migration from the body fluids from the dental sulcas contaminating the dental filling material during the filling process. This contamination reduces the bond strength of the composite dental filling material from bonding to the tooth. More specifically the bonding of the composite to the dentinal tubules is prevented.

Typically, the dental matrix bands of this invention are coated with NuSil product Med10-6640, a two part Platinum catalyzed polydimethyl siloxane. Primer use before coating is Med 1-161 silicone primer. Polydimethylsiloxane is the active coating material.

The dental matrix bands are preferably coated with NuSil product Med10-6640 two part Platinum catalyzed polydimethyl siloxane. Primer use before coating is Med 1-161 silicone primer. These NuSil products are available from, NuSil Technology LLC, 1050 Cindy Lane, Carpinteria, Calif. 93013.

Adhesion of the coating as dental matrix seal to any dental matrix device is assured by etching the surface of the dental matrix device. Etching of the matrix band may be accomplished in any suitable fashion. Mechanical abrasion, acid etching and photochemical etching are especially suitable processes for etching the matrix band, as long as the procedures are pharmaceutically acceptable. Pharmaceutically acceptable includes those materials suitable for use in a person's mouth.

Additionally, the matrix band may be etched by using mechanical abrasion. Mechanical abrasion may be obtained by subjecting the metal surface to a high velocity stream of silica particles or soft metal particles, or by rubbing the surface with a silica or diamond encrusted paper or metal sheet. Clearly, any abrasive system may be used. However, the chemical treatment is preferred.

The preferred method of applying coating, laminate or tapes to the separating strip is by using a pharmaceutically acceptable adhesive, but any other suitable method may be used.

Coatings with a thickness of about 0.015 millimeter to about 8.35 millimeters are adequate to reduce the capillary action. Coatings with a thickness of about 0.020 millimeter to about 7.35 millimeters reduce the capillary action more effectively. Coatings with a thickness of 0.025 (0.001 inch) millimeters to about 6.35 (0.25 inch) millimeters is most effective in reducing, if not eliminating, the capillary action.

Acid etching preferably occurs in a pharmaceutically acceptable acid at a pH of 4 to 6. More preferably, the pH is 4.2 to 5.9. Most preferably, the pH is 4.4 to 5.7. Below these pH ranges in a more acidic etching solution, the surface of the dental matrix device is compromised and cannot be made suitable for dental use. Above these pH ranges in a more basic etching solution, the surface of the dental matrix device is etched insufficiently so that a durable coating cannot be applied thereto and cannot be made suitable for dental use.

The etching acid can be any pharmaceutically acceptable acid having a pH in the desired range. Acetic acid, phosphoric acid, citric acid, hydrochloric acid and suitable mixtures thereof in the desired pH range are quite useful. This etching process is quite acceptable for the purposes of this invention.

A second etching process that may be used is photochemical etching. Photochemical etching appears to be the preferable method. Appropriate tests are run to determine if the matrix band is suitable for the coating process. After proper inspection, the matrix band is degreased and rinsed. The standard acid wash, followed by appropriate scrubbing and drying, is the final step for the inspection of the matrix band. A photo resist coating is bonded to the surface of the matrix band under a controlled temperature. A controlled ultraviolet light exposure is selectively applied to at least one selected area of the photo resist coating in order to polymerize certain sections thereof.

The unexposed matrix band coating is removed by a standard development system. This developing system dissolves the unexposed areas of the photo resist coating. Washing and cleaning then follows. The exposed parts of the matrix band are then etched with an acid on both sides thereof, if desired. A desired coating is applied to the etched surfaces.

The etching parameters are adjusted empirically as desired. An alkaline wash removes the remaining photo resist coating. The part is then recovered, and one achieves the desired coated matrix band of this invention.

The process of photo etching the stainless steel matrix band causes microscopic pits in the surface thereof. With a rolling of the two materials together after the photo etching, a micro-mechanical bond between the matrix band and the desired coating is achieved. This process can be adapted to the use of silicones and adhesive materials in order to successfully attach the seal or coating to the dental matrix band.

If desired, at least one aperture may be put in the matrix band. Such an aperture; situated in the central portion of a long edge of the matrix band, with the clamp between the aperture and the tooth around which the matrix band is placed; is used to assist with the removal of the band from the tooth. This can be accomplished with the standard dental tool commonly known as the explorer.

Referring now to the drawings, the following references to specific drawing figures are intended to illustrate without unduly limiting the invention disclosed herein. The polymer coated matrix band of this invention is a result of the etching treatments of the metallic matrix band prior to coating with the desired polymer.

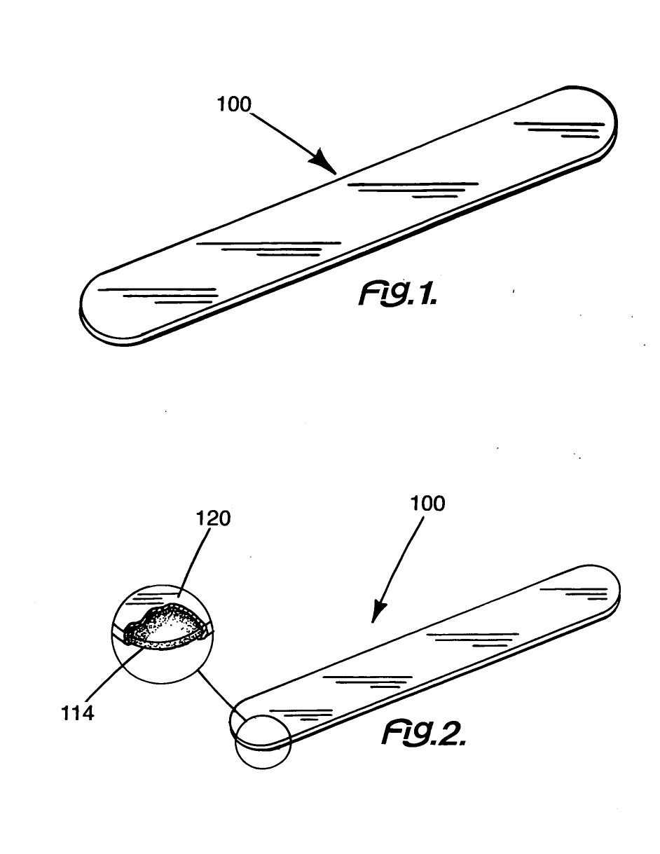

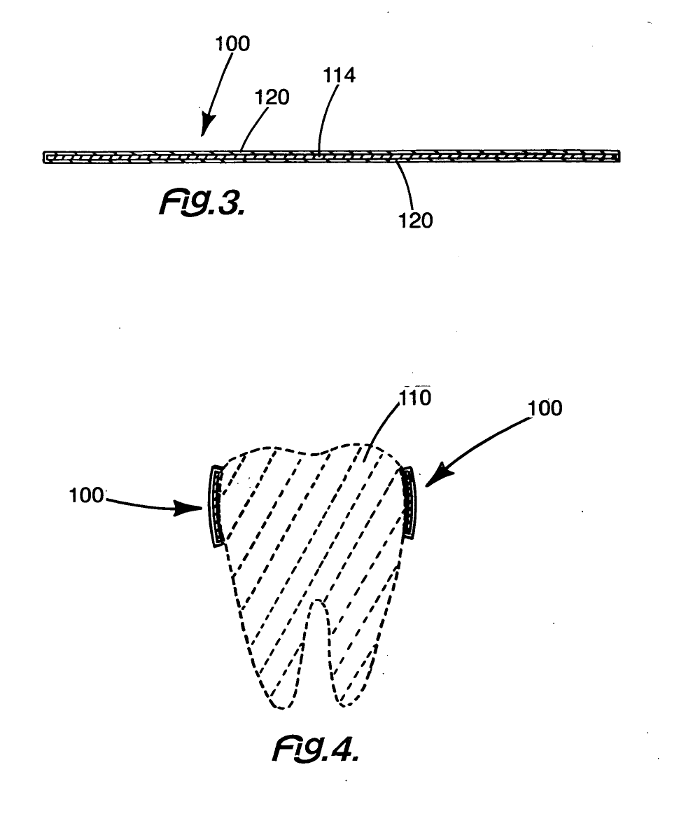

Considering now FIG. 1, FIG. 2, FIG. 3, and FIG. 4, the straight coated matrix band 100 has a support base 114 with a strip polymer 120 applied thereto. The strip polymer 120 is applied after the support base 114 is etched. Strip polymer 120 may have a rectangular cross section 122, although other suitable geometric shapes may be used. The straight coated matrix band 100 to a tooth 110 (FIG. 4) or removing the same therefrom. Matrix band 100 may also have removal apertures as shown in U.S. Pat. No. 6,749,429, to Haraden et al., incorporated herein by reference.

In the following examples, which are intended to illustrate without unduly limiting the invention disclosed herein, all parts and percentages are by weight, unless otherwise specified.

### EXAMPLE ONE

With the straight coated matrix band 100; having a strip silicone polymer 120 is applied onto a stainless steel support base 114 etched in an acetic acidic solution having a pH of 5.5, the strip polymer 120 being based on a pharmaceutically acceptable siloxane polymer. That straight coated matrix band 100 is applied to a tooth 110 under repair, where the coating provided a seal that prevented the ingress of fluid into the area of the tooth being repaired.

### EXAMPLE TWO

The procedure of Example One is repeated except that the etching solution is phosphoric acid and has a pH of 5.0. The coating adheres as well as in Example One.

### EXAMPLE THREE

The procedure of Example One is repeated except that the etching solution has a pH of 4.7. The coating adheres adequately but is not as durable as the coating set forth in Example Two.

### EXAMPLE FOUR

The procedure of Example One is repeated except that the etching solution has a pH of 6.2. The coating fails to adhere as in Example One.

### EXAMPLE FIVE

The procedure of Example One is repeated except that the etching solution has a pH of 4.0. The integrity of the support base 114 is compromised in that matrix is of insufficient strength to fit around tooth 110.

### EXAMPLE SIX

The procedure of Example One is repeated except that the acid etching process is replaced with the photo etching process. The coating adheres and provides an effective dental straight coated matrix band 100.

### EXAMPLE SEVEN

The procedure of Example One is repeated except that the acid etching process is replaced with the mechanical abrasion process utilizing a high velocity stream of silica aimed at the surface of the band to etch the surface. The coating adheres and provides an effective dental straight coated matrix band 100.

### EXAMPLE EIGHT

The procedure of Example Seven is repeated except that the acid etching process is replaced with the mechanical abrasion process utilizing a high velocity stream of soft metal particles aimed at the surface of the band. Such action forms a micro alloy on the surface. The coating forms and provides an effective seal that prevented the ingress of fluid into the area of the tooth being repaired.

### EXAMPLE NINE

The procedure of Example One is repeated except that the acid etching process is replaced with the mechanical abrasion process involving the buffing of the matrix band's surface with a silica or diamond encrusted sheet to etch the surface of the matrix band. The coating adheres and provides an effective seal that prevented the ingress of fluid into the area of the tooth being repaired.

This application; taken as a whole with the abstract, specification, claims, and drawings being combined; provides sufficient information for a person having ordinary skill in the art to practice the invention as disclosed and claimed herein. Any measures necessary to practice this invention are well within the skill of a person having ordinary skill in this art after that person has made a careful study of this disclosure.

Because of this disclosure and solely because of this disclosure, modification of this method and device can become clear to a person having ordinary skill in this particular art. Such modifications are clearly covered by this disclosure.

What is claimed and sought to be protected by Letters Patent of the United States is:

1. A matrix band for use in dentistry comprising:
a) the matrix band having a stainless steel surface; and
b) a silicone-based polymer coating the stainless steel surface in order to at least reduce a capillary action between a tooth and the matrix band.

2. The matrix band of claim 1 further comprising the stainless steel surface being etched prior to application of the silicone-based polymer.

3. The matrix band of claim 1 further comprising the silicone-based polymer providing a smooth surface for the matrix band.

4. The matrix band of claim 1 further comprising a silicone primer being applied prior to the coating of the silicone-based polymer.

5. A process for coating a matrix band for use in dentistry comprising:
a) providing a matrix band for use in dentistry;
b) etching the matrix band in a pharmaceutically acceptable manner to form an etched band; and
c) applying a silicone based coating to the etched band.

6. The process of claim 5 further comprising the etching of the matrix band being a mechanical abrasion, an acid etching or a photochemical etching.

7. The process of claim 6 further comprising the mechanical abrasion subjecting the matrix band to a high velocity stream of silica particles or soft metal particles, or rubbing the surface with a silica or diamond encrusted paper or metal sheet.

8. The process of claim 6 further comprising using a pharmaceutically acceptable adhesive to adhere the silicone based coating to the matrix band.

9. The process of claim 6 further comprising etching with a pharmaceutically acceptable acid at a pH of 4 to 6.

10. The process of claim 9 further comprising etching with a pharmaceutically acceptable acid at a pH of 4. 4 to 5.7.

11. The process of claim 10 further comprising acetic acid, phosphoric acid, citric acid, hydrochloric acid and suitable mixtures thereof in the desired pH range being an etching agent.

12. The process of claim 6 further comprising:
a) photochemically etching the matrix band;
b) degreasing the matrix band;
c) rinsing the matrix band;
d) scrubbing the matrix band;
e) drying the matrix band;
f) applying a photoresist coating;
g) selectively exposing the photoresist coating to ultraviolet light to form an exposed section and an unexposed section;
h) removing the unexposed section;
i) etching the matrix band; and
j) coating the matrix band.

13. The process of claim 12 further comprising:
a) removing the photo resist coating with alkaline wash; and
b) applying a coating to the matrix band.

14. The process of claim 6 further comprising:
a) putting an aperture in the matrix band; and
b) etching the matrix band with a mechanical abrasion, an acid etching or a photochemical etching.

15. The process of claim 14 further comprising the mechanical abrasion subjecting the matrix band to a high velocity stream of silica particles or soft metal particles, or rubbing the surface with a silica or diamond encrusted paper or metal sheet.

16. The process of claim 14 further comprising using a pharmaceutically acceptable adhesive to adhere the silicone based coating to the matrix band.

17. The process of claim 14 further comprising etching with a pharmaceutically acceptable acid at a pH of 4 to 6.

18. The process of claim 17 further comprising etching with a pharmaceutically acceptable acid at a pH of 4.4 to 5.7.

19. The process of claim 18 further comprising acetic acid, phosphoric acid, citric acid, hydrochloric acid and suitable mixtures thereof in the desired pH range being an etching agent.

20. The process of claim 14 further comprising:
a) photochemically etching the matrix band;
b) degreasing the matrix band;
c) rinsing the matrix band;
d) scrubbing the matrix band;
e) drying the matrix band;
f) applying a photoresist coating;
g) selectively exposing the photoresist coating to ultraviolet light to form an exposed section and an unexposed section;
h) removing the unexposed section;
i) etching the matrix band; and
j) coating the matrix band with a silicone-based polymer.
